(19) United States
(12) Patent Application Publication
(10) Pub. No.: US 2006/0220325 A1
(43) Pub. Date: Oct. 5, 2006

(54) Floating seal assembly for a trocar

(76) Inventor: Richard H. McFarlane, Singer Island, FL (US)

Correspondence Address: MALLOY & MALLOY, P.A., 2800 S.W. Third Avenue, Historic Coral Way, Miami, FL, 33129, US

(21) Appl. No.: 11/375,540

(22) Filed: Mar. 14, 2006

Related U.S. Application Data
(63) Continuation-in-part of application No. 10/424,564, filed on Apr. 28, 2003, now Pat. No. 7,011,314.
(60) Provisional application No. 60/376,033, filed on Apr. 26, 2002.

(51) Int. Cl. F16L 5/02

(52) U.S. Cl. 277/607

(57) ABSTRACT

A seal assembly used in combination with a trocar assembly and disposed and structured to establish sealing engagement with the exterior surface of medical instrument introduced into the trocar assembly so as to maintain adequate insufflation pressure within a body cavity accessed by the trocar assembly. The seal assembly includes a seal member unconnected to and freely moveable, at least laterally, within a seal chamber of the trocar assembly. The seal member and the seal chamber are cooperatively dimensioned to maintain one or more outer peripheral surfaces of the seal member in surrounding, sealing relation to one or both of the inlet and outlet ports of the seal chamber thereby eliminating or reducing the escape of insuflation gas through the trocar assembly when an instrument is present therein.

### CLAIM OF PRIORITY

This application is a continuation-in-part of a previously filed application, having Ser. No. 10/424,564 and a filing date of Apr. 28, 2003, which is set to mature into U.S. Pat. No. 7,011,314 on Mar. 14, 2006, which was based on and includes a claim of priority pursuant to 35 U.S.C. Section 119(e) to a prior filed provisional patent application, namely, that having Ser. No. 60/376,033 and a filing date of Apr. 26, 2002, both of which are incorporated in their entireties herein by reference.

### BACKGROUND OF THE INVENTION

1. Field of the Invention

This invention relates to a seal assembly of the type normally used with a trocar or like device structured to introduce medical instruments into the body cavity of a patient for purposes of performing surgery. The seal assembly includes a seal member freely movable within a chamber of a seal housing, whether formed as part of the trocar or attached thereto, and generally overcomes recognized disadvantages associated with conventional seal assemblies. The present invention has an ability to better maintain a seal about a medical instrument's outer diameter while the instrument is being manipulated and moved about during a surgical procedure and is resistant to being damaged when a medical instrument is being introduced into and/or removed from the trocar. In addition, the present invention also has an ability to accommodate medical instruments having various outer diameters within a certain range.

2. Description of the Related Art

Laparoscopic surgery has become quite common in recent years as it generally avoids several significant drawbacks associated with previous surgical methods. Those methods involved the making of large incisions into a patient's body so as to give the surgeon clear and unobstructed visual access to the targeted organ(s) or anatomical tissue of the patient for the surgical procedure involved. In stark contrast, the currently favored surgical technique of laparoscopy involves the forming of one or more small entry sites in the patient's abdominal wall for accessing his or her body cavity, using a trocar or like device to provide a working channel, and performing surgery on the targeted organ(s) or tissue via a medical instrument inserted into the trocar or like device. Following this type of surgery, patients usually experience significantly less pain and recover much more quickly than when the older surgical methods were used, and as a result, the minimally invasive procedures of laparoscopy have become well accepted in the medical field.

The trocar assembly used in performing laparoscopic surgery typically includes an elongated tube or cannula, into which an obturator is inserted, which most often has a sharp distal tip that protrudes beyond the distal end of the elongated tube or cannula. The formation of the surgical path into the patient's body cavity, such as but not limited to an abdominal cavity, usually involves the initial cutting of a small surgical entry site and introduction of the obturator's sharp distal tip into it, followed by the elongated tube or cannula of the trocar assembly, as the obturator's distal tip is advanced to cut or otherwise move through the patient's bodily tissues, until the wall or thick lining of the abdominal cavity is punctured. At that point, the obturator is usually removed from the trocar cannula and the patient's abdominal cavity is inflated with a suitable gas, such as carbon dioxide, to provide space within the abdomen for the surgery to take place. The trocar or like device remains in place at the entry site(s) and functions as a working channel across the abdominal tissues and thick lining of the abdominal cavity, and into that cavity, such that relatively thin and long handled instruments, including forceps, scissors, retractors, dissectors, etc., as well as a tiny video camera and light source, which are all specifically designed for this purpose, may be inserted through the trocar. Of course, there will often be more than one trocar in place during surgery. While positioned in a trocar, the chosen medical instrument is manipulated by the surgeon into contact with the patient's organ(s) or anatomical tissue, as targeted by or otherwise involved with the surgical procedure being performed.

As noted above, during laparoscopy the patient's abdominal cavity is typically insufflated, usually by the attachment of a source of gas to the trocar assembly, which gas is forced under pressure into the accessed abdominal cavity. Once that cavity is inflated, it is important that the fluid pressure within the body cavity be maintained in order to provide the needed access to the internal organs, as well as adequate room for visual observation during the surgical procedure. Therefore, it is important to prevent the escape of pressurized fluid from within the body cavity, back through the cannula and/or housing associated with the trocar. This is commonly achieved by the use of valves or sealing mechanisms within the trocar, and both “septum” valves and “zero closure” valves are used for this purpose. For example, it is known to use “septum” valves located at the proximal end of the trocar, usually within the trocar's housing, to form a seal around the outer surface of a medical instrument which has been inserted within the trocar. However, these types of seals will not usually prevent the escaping of gas once a medical instrument has been removed from the trocar. As such, it is also known to provide trocars with a “zero closure” valve to prevent gas from escaping when there is no medical instrument present within the trocar.

The present invention relates generally to the former type of seal, i.e., that achieved by septum valves for sealing about the outer surface of medical instruments. However, there are a number of competing factors to consider in providing this type of seal mechanism, and there is substantial room for improvement over those which are currently known in the art, as will now be explained.

First, and as indicated above, laparascopic surgery can involve a variety of medical instruments during any given surgical procedure and there are also a number of manufacturers of such instruments. Accordingly, among other things, the outer diameters of these medical instruments can and do vary. For example, it is quite common for the outer diameters of such medical instruments to vary within a currently conventional range from about 3 mm to 15 mm. This fact, however, presents an obstacle for preventing the escape of gas by or via the septum valve because the valves known or used for this purpose typically accommodate and effectively seal against only one set size of a medical instrument's outer diameter or one sized very closely thereto.

This, in turn, causes some disruption in the performance of the surgery. For example, the septum valve will not seal adequately around a medical instrument having a smaller outer diameter (“OD”) than the set size offered by the septum valve, meaning that some gas will escape when a medical instrument having smaller OD is used, and the abdominal cavity may have to inflated again, etc. As another example, if a medical instrument having a much larger outer diameter must be used, which is beyond the size of the septum valve, there may be an unacceptable drag or friction force exerted on the instrument during its insertion into or removal from the trocar, and while it is being manipulated during surgery. Further, the septum valve may become ripped, torn or otherwise damaged, leading to a loss of insufflation gas and/or a need to replace the trocar, etc. during surgery.

Some in the art have attempted to solve this problem by providing an attachment device for the trocar, which provides another or supplemental septum valve to accommodate the use of medical instruments having differently sized outer diameters during surgery. However, such devices must still be manipulated and/or somehow attached to the trocar to permit use during surgery, which interrupts the surgery somewhat and which can be cumbersome as the user's hands may be wet, bloodied or otherwise slippery.

Second, and as also noted above, during laparoscopic surgery the trocar remains inserted across the patient's abdominal tissues, wall, and into the abdominal cavity, acting as the working channel into which the various medical instruments are inserted or removed. However, during a surgery the trocars are often disposed at various angles, meaning that when a medical instrument is introduced into the trocar, and even during the surgery itself, it will often be oriented in an angularly, off-set position relative to the trocar, meaning the instrument is initially likely to be out of axial alignment with the central axis of the trocar housing, including with any septum valve associated therewith. This, in turn, can also cause some disruption in the performance of the surgery. For example, known septum valves are usually made of a very thin, flexible material which can be punctured or ripped when a medical instrument is inserted at an angle, and that can result in the loss of some insufflation gas during surgery, delay if the trocar must be replaced, etc. Also, while a surgery is in progress the manipulation of medical instruments within the trocar has been known to cause the septum valves to become “egg-shaped,” which also typically results in the loss of some insufflation gas.

Despite the recognition of these and other obstacles, and attempts to address them, there remains an appreciable need for an improved mechanism or assembly for sealing about the outer diameter or surface of medical instruments used in trocars or like devices. If any such improved sealing mechanism were developed, it should be suitable for and readily used with a trocar assembly or like device, and further, should effectively maintain insufflation pressure within a patient's body cavity, once it has been accessed and inflated. Any such improved sealing mechanism should also accommodate and/or facilitate the introduction of medical instruments into the trocar, even when oriented in an angular, off-center position relative to the longitudinal axis of the trocar and/or the inlet port associated therewith, and should also resist the formation of ovals or “egg-shapes,” especially when the medical instrument is being forcibly manipulated and otherwise used during surgery. Further, if any such improved sealing mechanism were developed, it should also be structured to prevent or significantly reduce the possibility of damage thereto, especially when the seal assembly comes into contact with the distal end of a medical instrument being introduced. Any such improved sealing mechanism would preferably also be capable of accommodating a number of medical instruments, including ones having various outer diameters, such as, but not limited to, those falling within the currently conventional range of about 3 mm to 15 mm. Ideally, any such improved sealing mechanism would also accomplish all of the foregoing without creating excessive drag or friction on the medical instrument while it is being inserted into or removed from a trocar or otherwise moved about during the performance of the surgery.

### SUMMARY OF THE INVENTION

This invention is intended to present a solution to these and other needs which remain in this field of art and is directed to a seal assembly that is primarily structured to be used with a trocar or like device that facilitates the introduction of medical instruments through an anatomical wall and into the interior of a body cavity of a patient, such as during laparoscopic surgery. The seal assembly of the present invention incorporates an inventive seal member, features of which are discussed in detail subsequently herein, and as such, the present application includes some claims drawn to the seal member, alone, as well as to the inventive seal assembly.

More specifically, the seal assembly of the present invention includes a seal member that is structured to be freely movable or “floating” within the interior of a chamber, which may be formed within the housing of a trocar or formed separately and attached to the trocar. The seal assembly is structured to allow for and accommodate the passage of a plurality of medical instruments there-through, and preferably, instruments having differently sized, outer diameters. As noted previously herein, medical instruments used in laparoscopic surgery are currently available with outer diameters that fall into a conventional range of about 3 mm to 15 mm, and while the present invention can, in one embodiment, accommodate a narrower range of instruments' outer diameters, such as 5 mm to 12 mm, or in other embodiments, such as 5 mm to 8 mm or 10 mm to 12 mm, it will ideally be able to seal about a wider range of instruments' outer diameters, such as but not limited to the conventional range noted above.

The seal member of the present invention is preferably formed of an elastomeric material, and so as to have an integral, one piece construction. The seal member includes oppositely disposed, first and second outer surfaces and a channel extending there-through in communicating relation with the first and second outer surfaces. The channel is preferably, but not necessarily, centrally disposed within the seal member. The seal member includes at least one interior surface, if not two interior surfaces, which at least partially define both the configuration and the boundaries of the channel. The interior surface or surfaces associated with the channel is/are disposed and structured to movably engage the exterior surface of any medical instrument passing through the channel, and further, is/are sized, configured and otherwise structured to maintain sealing engagement about the exterior of the instrument, despite the fact that the outer diameter of the instruments may vary, as noted above.

Also, at least the first outer surface of the seal member is configured to accommodate the introduction of a medical instrument in an angled or skewed orientation relative to the channel. More in particular, during a laparoscopic surgical procedure it is quite common for medical instruments to be introduced into the trocar in an orientation which is not perfectly aligned with the central longitudinal axis of the trocar housing or cannula. This angled or skewed orientation of the instrument as it is being introduced into the trocar has been known to cause damage to previously known sealing mechanisms within the trocar, due to the exertion of substantially obliquely directed forces, and especially in situations where the distal end of the instrument carries scissor blades, clippers or is otherwise sharp. However, the seal assembly of the present invention overcomes such disadvantages by providing a seal member which freely moves or “floats” within a chamber. Therefore, upon introduction of a medical instrument, the seal member is capable of moving laterally within the chamber to accommodate the introduction of the instrument in an angled or skewed orientation, i.e., one which is not in alignment with the intended direction of travel of the instrument down the central axis of the trocar cannula. In addition, and as noted above, the seal member has in a preferred embodiment at least its first outer surface of the seal member, if not the oppositely disposed, second outer surface as well, configured to facilitate the passage of the distal working tip of the medical instrument into the interior of the channel and along the interior surfaces thereof. For example, at least one of the illustrated embodiments depicts an interior surface at the open end of the channel as having a flared configuration.

As noted above, the seal assembly of the present invention includes a seal member that is capable of moving freely in at least a lateral or radial direction within the seal chamber, and yet, sealing engagement is still provided by the seal member about the exterior surface of a medical instrument inserted into the channel thereof. In addition, sealing engagement is provided for within the chamber itself, around the peripheral surfaces of the seal member and between the lower and upper interior surfaces of the chamber, due to the cooperative dimensioning between the seal member and the interior of the chamber, as noted above. As such, the present invention readily accommodates the frequent manipulation of the medical instrument introduced into the body cavity by the surgeon in a number of directions without allowing a leak to form or the insufflated gas to otherwise escape.

The floating seal assembly of the present invention includes a seal member in yet another preferred embodiment, namely, one having a first section and a second section. The first and second sections are preferably independently structured, such that the respective structural components of each of the first and second sections are integrally or otherwise connected to one another. Although the first and second sections may be snugly and matingly interconnected to assume an operative position within the interior chamber of the seal housing of the trocar assembly, they are also preferably removably connected to one another. Also, while the first and second sections will preferably be independently fabricated and subsequently connected or assembled to assume the intended operative position, it is noted that the first and second sections may be integrally formed or otherwise fabricated as a one piece structure.

In this alternative preferred embodiment, the first section of the seal member comprises an inner sleeve including a substantially convergent configuration, and further, with the inner sleeve disposed on the interior of the seal member. The second section of the seal member includes a seal structure also having a convergent configuration substantially corresponding to the inner sleeve of the first section and which is disposed in at least partially aligned relation therewith. Further, both the inner sleeve and the seal structure include an apertured construction more specifically defined by an opening and a sealing aperture respectively formed in the downstream or exit ends of the inner sleeve and the seal structure. Moreover, the opening in the inner sleeve and the sealing aperture in the seal structure are normally disposed in aligned and/or coaxial relation with one another especially, but not exclusively, when an instrument is not present within or passing through the seal member.

In order to effectively accomplish the necessary sealing engagement between the seal member and a medical instrument passing through the trocar, the flexibility and/or elasticity of the material of the seal structure of the second section facilitates sealing engagement between the inner periphery of the sealing aperture and the outer surface of the instrument. The inner sleeve is also sufficiently elastic and/or flexible to be movable within the interior of the seal member. These flexible and/or elastic characteristics of the inner sleeve and the seal structure allow them to readily adapt to the dimension and angular orientation of an instrument passing into the seal housing and along the interior channel of the seal member. While a variety of materials demonstrate sufficient flexibility and/or elasticity to accomplish the intended purpose and function of the inner sleeve and seal structure, each are preferably formed from an elastomeric material.

Still referring to this alternative preferred embodiment of the seal member, another inventive feature relates to the disposition of the inner sleeve in an interruptive relation as a medical instrument is being introduced into the trocar, and prior to the instrument's reaching the seal structure of the seal member's second section. More specifically, the inner sleeve is disposed between the inlet port of the seal housing and the seal structure. As such, the inner sleeve, while not being directly connected to the seal structure, at least partially overlies the seal structure and is moveable with and relative to the seal structure. Also, the inner sleeve and the seal structure are typically forced into an “offset” or deformed orientation when the instrument enters the seal housing at a skewed angle and engages with the seal member. Such a skewed angle may be generally considered to be any angular orientation of the instrument other than being coaxial with the central longitudinal axis of the seal member. However, even when in the aforementioned offset orientation, the seal member is always disposed in communicating relation with the outlet port of the seal housing and the interior of the cannula.

In that inner sleeve assumes an “interruptive disposition” between the sealing structure and a medical instrument entering the seal housing, the inner sleeve is preferably formed from a material resistant to puncturing, tearing or like damage by the leading end of the instrument. However, the inner sleeve should also demonstrate sufficient flexibility and elasticity for the reasons set forth above. As such, the material from which the inner sleeve is formed may have a durometer reading such as in the range of generally about 80 durometers. In contrast, the seal structure should demonstrate sufficient elasticity or like structural and performance characteristics to accomplish a substantially fluid tight seal between the periphery of the sealing aperture and the exterior surface of the instrument. Accordingly, the durometer reading of the seal structure will preferably be, but does not have to be, lower than that of the inner sleeve, in order that it demonstrates sufficient flexibility and/or elasticity to accomplish an effective seal with the entering instrument. As indicated above, and described in greater detail hereinafter, sealing engagement between the instrument and the seal member prevents or at least minimizes the escape of insuflation gas when the instrument is present in the trocar and extends through the seal member.

Yet another feature of this preferred embodiment of the seal member includes the interior or exposed face of the inner sleeve member having an irregular surface configuration. Such an irregular surface configuration may, in at least one preferred embodiment, be more specifically defined by a substantially “pleated” construction. Such a pleated construction comprises a plurality of raised, elongated pleats separated by a plurality of elongated recesses extending substantially along the length of the pleats. It should be noted, that the flexible nature of the material from which the inner sleeve is formed allows for at least a minimal expansion and/or contraction of the of pleats relative to one another as the exposed face of the inner sleeve engages a medical instrument entering the trocar. It is further emphasized that while the irregular surface configuration may be defined by the aforementioned pleated construction, other irregular surface configurations can be formed on the exposed face of the inner sleeve.

While the specific structure of the irregular surface configuration utilized may vary, the operative features of the exposed face of the inner sleeve, including the irregular surface configuration formed thereon, preferably include the ability to facilitate the guidance of the leading end of a medical instrument in terms of passing into the trocar, into and through the sealing aperture of the seal structure. Efficient sealing engagement between the seal structure and the exterior surface of the instrument is thereby facilitated. Also, the irregular surface configuration of the inner sleeve will preferably be such as to result in a reduced frictional engagement with and resistance to passage of the instrument into and through the seal member.

These and other objects, features and advantages of the present invention will become clearer when the drawings, as well as the following detailed description of the invention in one or more preferred embodiments, are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of one possible type of a trocar assembly with which the seal assembly of the present invention may be utilized.

FIG. 2 is a perspective view of the seal member of the present invention in a first preferred embodiment.

FIG. 3 is a schematic cross-sectional view of a seal member according to the present invention, in an embodiment somewhat modified from that shown in FIG. 2.

FIG. 4-A is a perspective view in exploded form of a seal assembly according to the present invention, including a seal housing and seal closure or cap, in which a seal member such as that shown in FIG. 2 is operatively disposed.

FIG. 4-B is a perspective view of the seal assembly illustrated in FIG. 4-A assembled and attached to the trocar assembly illustrated in FIG. 1.

FIG. 5 is a schematic cross-sectional view of a seal assembly of the present invention, such as that shown in FIG. 3, but illustrated in an assembled, operative position and more clearly illustrating the seal member disposed and/or sandwiched within a chamber, formed in this embodiment by the seal closure or cap partially receiving the seal housing.

FIG. 6 is a schematic, cross-sectional view of yet another embodiment of the seal assembly of the present invention shown in an assembled, operative position.

FIG. 7 is a bottom perspective view of the seal member in the embodiment shown in FIG. 6.

FIG. 8 is a top perspective view of the embodiment of the seal member of FIG. 7.

FIG. 9 is a schematic, cross-sectional view of a seal member according to the present invention in yet another embodiment.

FIG. 10 is a perspective view in partial phantom and schematic form representing the operative position of the seal assembly according to the present invention in yet another preferred embodiment and within another possible type of trocar assembly.

FIG. 11 is a perspective view of the seal member shown in FIG. 10 and in assembled form.

FIG. 11A is a perspective, exploded view of the seal member shown in FIGS. 10 and 11, illustrating the first section and second section thereof in unassembled form.

FIG. 12 is a top view of the first section of the seal member of the preferred embodiment of FIGS. 11 and 11A.

FIG. 13 is a sectional view in partial cutaway taken along lines 13-13 of FIG. 12.

FIG. 14 is a bottom view of the first section of the seal member illustrated in FIGS. 12 and 13.

FIG. 15 is a top view of the second section of the seal member illustrated in FIGS. 11 and 11A.

FIG. 16 is a sectional view in partial cutaway taken along lines 16-16 of FIG. 15.

FIG. 16A is a sectional view in partial cutaway of a structural modification representing yet another embodiment of the second section similar to the embodiment of FIG. 16 but distinguishable therefrom.

FIG. 17 is a bottom view of the second section of the seal member shown in FIG. 16.

FIG. 18 is an exploded view in partial cutaway illustrating the first and second sections of the seal member of the embodiment of FIG. 11A, just prior to being assembled.

FIG. 19 is a sectional view in partial cutaway of the first and second sections of the seal member shown in FIGS. 11A and 18, yet in assembled form.

FIG. 20 is a cross-sectional view illustrating the introduction of a medical instrument into the interior chamber of the seal housing of the trocar assembly and through the seal member, as disposed in one of a plurality of possible operative positions within said chamber.

FIG. 21 is also a cross-sectional view similar to that of FIG. 20, but illustrating the seal member in another one of a plurality of possible operative positions and absent the presence of a medical instrument being introduced into the seal housing of the trocar assembly.

FIG. 22 is also a cross-sectional view similar to that of FIGS. 20 and 21, but illustrating the seal member with a medical instrument being inserted within it and passing there through.

Like reference numerals refer to like parts throughout the several views of the drawings.

### DETAILED DESCRIPTION OF THE INVENTION IN PREFERRED EMBODIMENT(S)

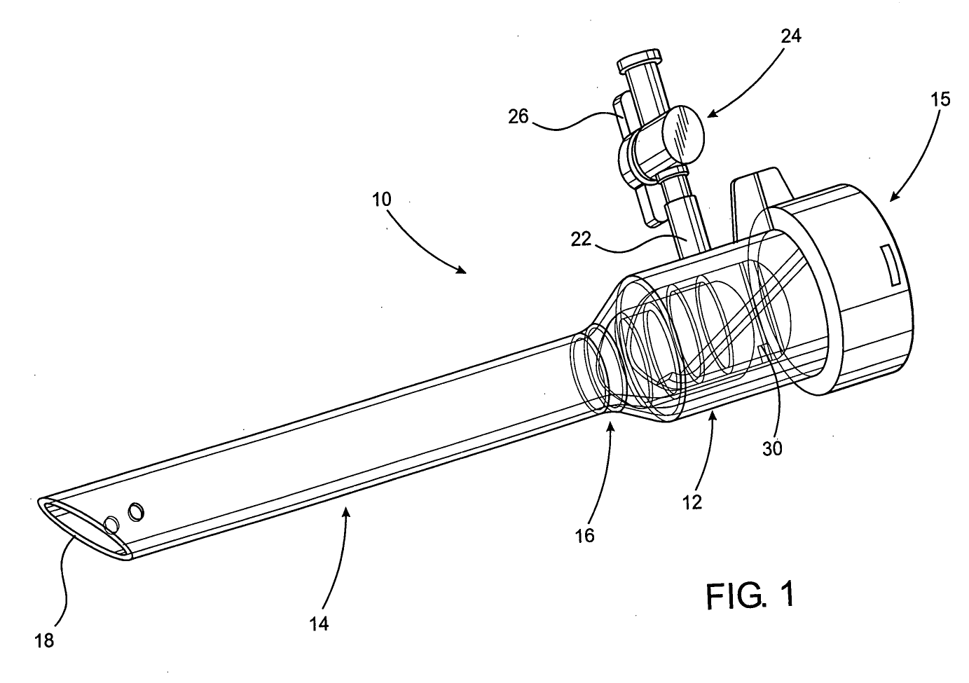

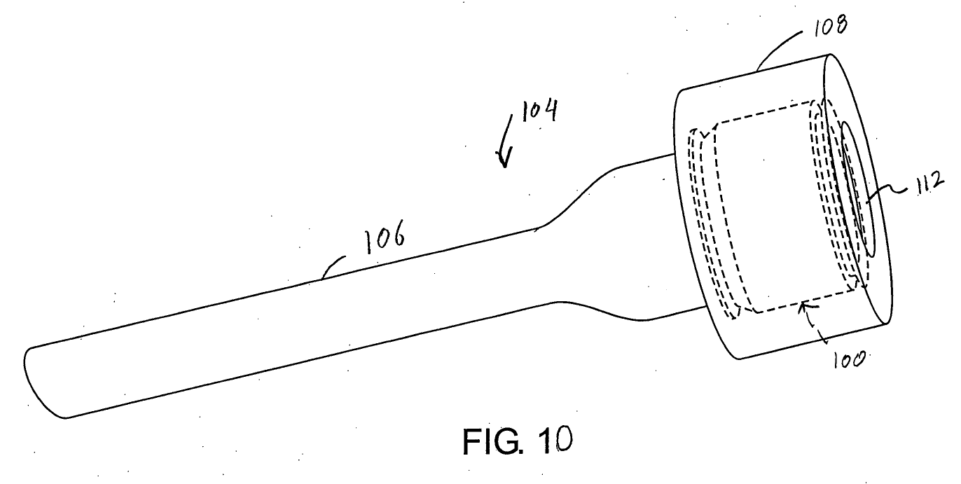

The present invention is directed to a seal assembly that is primarily structured to be used with a trocar, as shown in FIGS. 1 and 10, or a like device associated with the introduction of medical instruments through anatomical tissues and into the body cavity of a patient, such as during laparoscopic surgery. It is to be understood at the outset that the present invention is susceptible of embodiment in different forms. While there is shown in the drawings and will be described in detail herein at least one specific embodiment, it is with the understanding that the present disclosure is to be considered as an exemplification of the principles of the invention which should not limit the invention to the embodiment or embodiments illustrated.

With initial reference to FIG. 1, there is illustrated one possible type of a trocar assembly, indicated generally as 10, with which the seal assembly of the present invention may be used. The present invention is, however, readily suitable for use with other types of trocars, such as but not limited to, trocar 104, shown in FIG. 10. Generally, and still referring to FIGS. 1 and 10, the trocar assembly 10 or 104, includes a housing 12 or 108, and an elongated hollow sleeve or cannula generally indicated as 14 or 106, either attached to or integral with a distal end of the housing 12, as best shown at 16 in FIG. 1. Continuing with reference to FIG. 1, the opposite end 18 of cannula 14 is open to allow the distal working end of medical instruments inserted into the trocar 10 to pass into the patient's body cavity for use during surgery, and also to allow insufflation fluid to pass into the body cavity. In particular, the trocar housing 12 will typically include a port or coupling, such as that illustrated at reference numeral 22, which is disposed and configured to receive a connector generally indicated as 24. The connector 24 is structured for attachment to a source of gas or insufflation fluid which is to be introduced into the port or coupling 22 under pressure. The insufflation fluid may be carbon dioxide or another commonly use gas conventionally employed to inflate and expand the internal body cavity of a patient and thereby, permit a surgical procedure to be performed by providing increased working space within the body cavity. The connector 24 may include a control knob 26 which regulates fluid flow of the gas into the interior of the trocar housing 12 through the connector 24.

As explained previously herein, the trocar assemblies 10 and 104 are structured to receive any one of a variety of medical instruments. For example, one type of medical instrument might be an elongated rod having a pair of small scissors formed at its distal working end and a small handle at its proximal end. With reference to FIG. 1, the distal working end of the medical instrument is initially introduced into the trocar housing 12 at proximal end 15 and passed through the trocar housing 12 and along the length of the cannula 14. As has also been described, and as is generally known in the art, the medical instrument is of a length sufficient to permit its distal working end to extend beyond the open end 18 of the trocar cannula 14 and carry out surgery on the targeted organs of the patient, by the surgeon's manipulation of the handles attached to the instrument, which remain disposed outside the trocar housing's proximal end 15 during surgery. The housing 12 and cannula 14 of the trocar include an at least partially hollow interior disposed in communicating relation with each other in order to that the medical instrument may pass there-through. It will be noted from FIG. 1 that both the housing 12 and cannula or sleeve 16 of the trocar 10 are represented as being transparent. However, this is primarily for illustration purposes only, as the housing 12 and/or cannula 16, as well as other portions of the trocar assembly 10, can be and often are typically formed of an opaque and/or translucent material.

As described previously herein, during surgery it is important to prevent the escape of pressurized gas from the patient's body cavity, and as such, the trocar assembly 10 includes one or more valve or sealing mechanisms to accomplish this. For example, the trocar housing 12 will often include a “zero closure” valve such as, but not limited to, a flapper and/or “duck bill” type of valve, which can be opened to allow passage of the medical instrument but which closes to prevent gas from escaping, once the instrument has been removed from the trocar 10. Illustrated in the trocar housing 12 of FIG. 1, however, is an inventive and proprietary valve assembly 30 which has been disclosed in U.S. Pat. No. 6,692,467, issued on Feb. 17, 2004 and which is incorporated herein in its entirety by reference. Also, most trocars include another valve or sealing mechanism to form a seal around the outer surface of a medical instrument when one is present within the trocar, and a “septum valve” is often utilized for this purpose. With reference to FIG. 1, a septum valve can be incorporated into the trocar assembly 10 at its proximal end 15. The present invention, however, provides an improvement in this latter type of seal, i.e., for sealing about the outer surface of medical instruments.

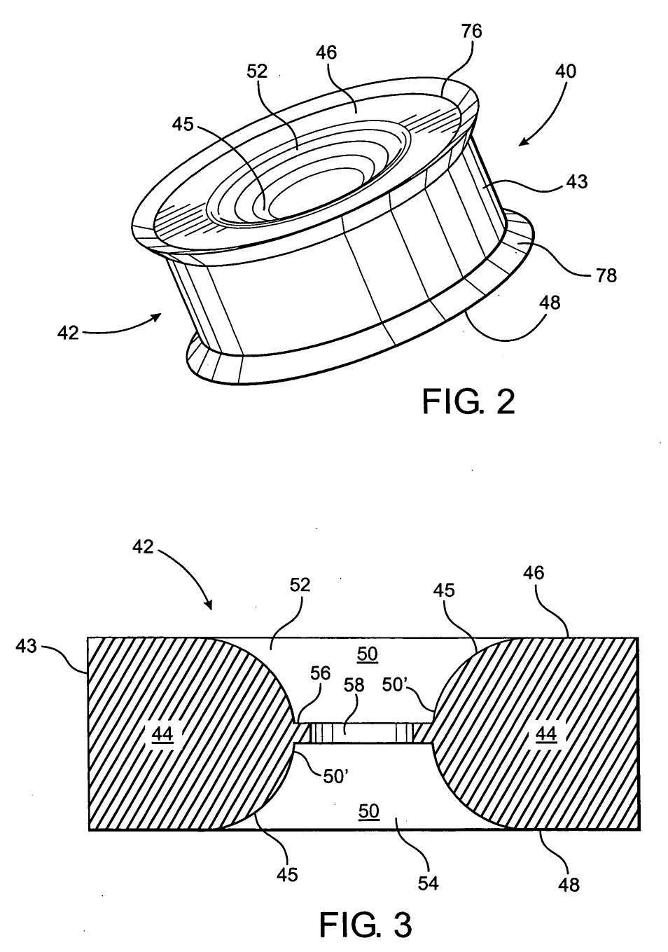

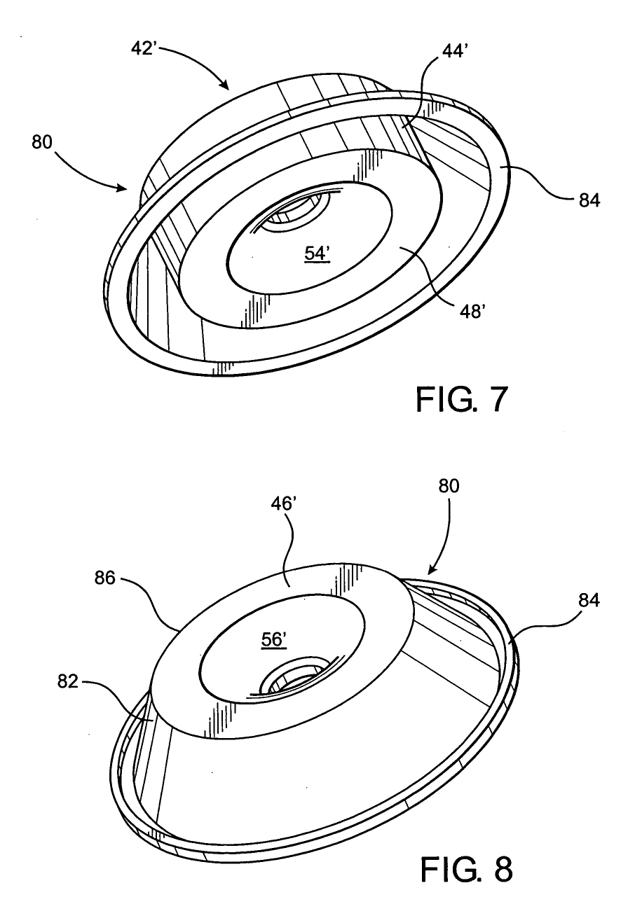

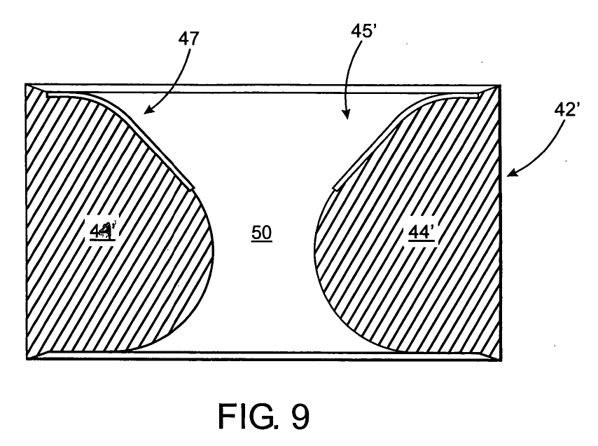

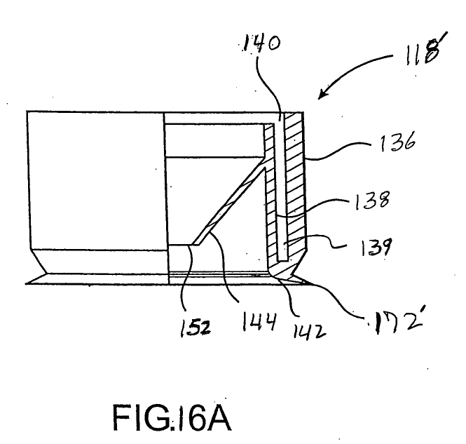

The present invention is directed to a seal assembly 40, one embodiment of which is illustrated in FIGS. 2 through 4, with another embodiment shown in FIGS. 6-8, another in FIG. 9, and yet another in FIGS. 11-22. It is currently intended by the inventor hereof that the seal assembly 40 functions in cooperation with another valve assembly mounted at least partially within the trocar housing 12, such as that indicated in FIG. 1 by reference numeral 30, for preventing insufflation gas from escaping when there is no medical instrument passing within the trocar. However, it is possible that the seal assembly 40 of this invention could be used without a valve assembly 30, but also, that it could be used with a variety of other valve structures, aside from the valve assembly 30 illustrated in FIG. 1.

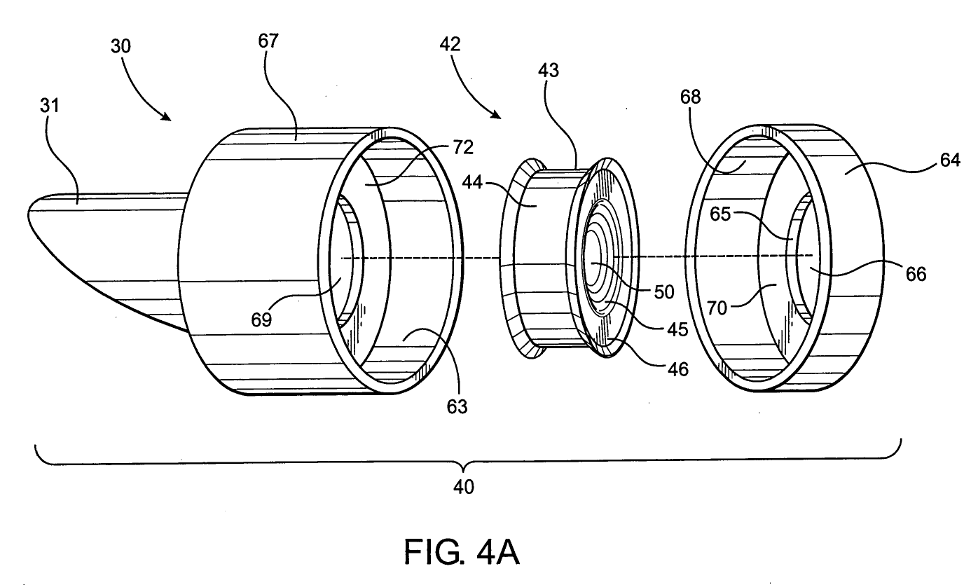

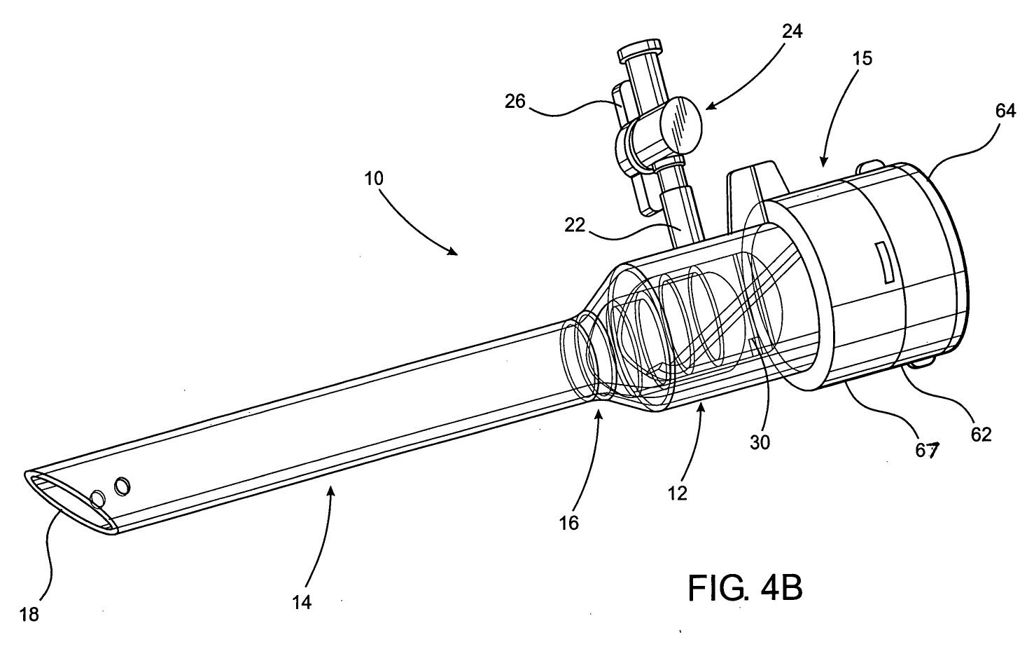

As illustrated in FIGS. 2 and 4-A through 5, the seal assembly of the present invention is shown in one embodiment and is indicated generally as 40. The seal assembly 40 comprises a seal member 42 formed of an elastomeric material and which preferably, but not strictly necessarily, comprises an integral, one piece construction. The elastomeric material used to form the seal member 42 can be silicone or polyurethane or other material, such as a urethane compound, rubber-like compound, etc. The seal member 42 can be formed by suitable means such as injection molding or the like, and while it may be formed to have a hardness in the range of fifty (50) durometers, it can be less, and potentially significantly less such as in the range of three (3) durometers, so as to more readily accommodate a wider range of medical instruments' outer diameters and provide less frictional forces on a medical instrument as it is moved into and of the trocar 10.

As is perhaps best illustrated in FIGS. 2, 3 and 4A, the seal member 42 is defined by a body 44 having a first outer surface 46 and a second, oppositely disposed outer surface 48 and a generally cylindrical body wall 43. Moreover, the body 44 of seal member 42 includes a channel or bore 50 extending completely there-through, with oppositely disposed open ends 52 and 54. As best shown in FIG. 3, the open ends 52 and 54 are disposed substantially contiguous to the first and second outer surfaces 46 and 48, respectively. Also, the body 44 of seal member 42 has an interior surface 45 which is disposed in surrounding relation to the channel 50, including at least one of the opposite open ends, such as 52, such that the interior surface 45 substantially defines the boundaries of the channel 50. At least one of the open ends of the channel 50, such as end 52 defined by interior surface 45, includes, although both open ends 52 and 54 can and preferably will include, a substantially flared configuration such that they diverge outwardly from a mid-portion or interior of the channel 50, indicated by 50′ in FIG. 3, towards the respective outer surfaces 46 and 48 of the seal member 42.

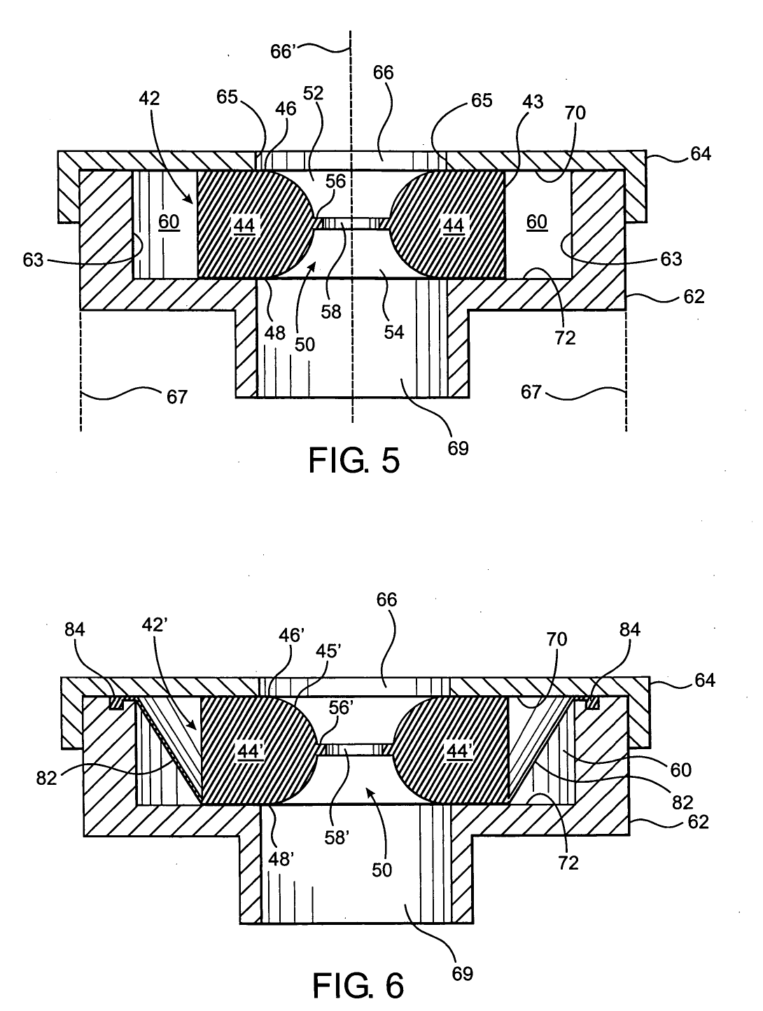

As has been described, the seal assembly 40 is structured and primarily intended for use with a trocar assembly 10 such as, but not limited to, the type disclosed in FIGS. 1 and 10. Referring now to FIGS. 4A-4B and FIG. 5, it will be seen that once assembled and in an operative position, the seal assembly 40 includes the seal member 42 being captured but freely movable within a chamber 60 formed within a seal housing 62. For example, the housing of the trocar 12 can be formed to include at its proximal end 15 a floor or lower portion 72 of the chamber 60, and a closure or seal cap 64 can be fixedly or removably connected to the seal housing 62 to define the chamber 60 within the seal housing 62, as best shown in FIGS. 4-A and 5. In FIGS. 4-A and 4-B, the seal housing 62 is illustrated as being disposed in communicating relation with a valve housing 67 that is part of and/or that is movably disposed within the housing 12 of the trocar 10. The valve housing 67 is part of a valve assembly 30, described previously that is considered an inventive and/or proprietary embodiment for which separate patent protection is currently pending, although it is pointed out that other valve assemblies 30 can be utilized with the seal assembly 40 of the present invention.

As also shown in FIGS. 4A-5, the closure or seal cap 64 includes an inlet port 66 directly communicating with the chamber 60 and the seal member 42 movably disposed therein. The inlet port 66 is dimensioned to accommodate the passage therethrough of a variety of medical instruments, each of which may have a differently sized outer diameter falling within the currently conventional range of about 3 mm to 15 mm, or more likely 5 mm to 12 mm. Because the seal cap 64 is made of a rigid material, such as plastic, the port 66 can be sized for example to receive instruments having the largest outer diameter, such as 12 mm or 15 mm. Alternatively, the inlet port 66 of seal cap 64 can be sized to receive smaller outer diameter instruments, but accommodating those having the largest outer diameter relative to a specified range, such as 5 mm-8 mm for instance. Regardless, the closure or seal cap 64 is preferably fixedly secured to form the seal housing 62, such as by bonding, etc. or alternatively, it could be structured to be removably connected and/or snapped on to form the seal housing 62. As another alternative, the seal housing 62 could be formed and/or assembled into one integral piece including the seal member 42 therein, for attachment onto the proximal end 15 of a trocar, as illustrated generally in FIG. 1.

Referring to FIG. 4-A, a medical instrument introduced into the trocar assembly 10 will initially pass through the inlet port 66 and seal cap 64, and then through channel 50 of the seal member 42, wherein at least a mid-portion or interior 45 of the channel 50 establishes sealing engagement with the exterior thereof. Continued travel of the instrument causes it to pass through valve housing 67 and aperture 69 thereof, and through a valve mechanism such as seat 31 or other components of a valve assembly 30, located “downstream” of the inlet port 66 and seal member 42. With the medical instrument inserted into the trocar 10, the valve assembly 30 is or will be disposed in an open position, and as such the instrument is permitted to continue travel through the trocar 10 and cannula 14 to establish communication with the interior of the patient's body cavity being accessed. While it then becomes possible for insufflation gas forced into the patient's body cavity to travel “upstream” into the trocar cannula 14 and housing 12 and beyond the valve assembly 30, since it is maintained in an open position, the seal assembly 40 is disposed, dimensioned, configured and structured to prevent escape of the insufflation gas beyond the seal housing 62, as will be explained more specifically hereinafter.

Referring now to FIG. 5, the seal member 42 is shown in an operative position within the chamber 60 of seal housing 62 and as described, while captured within the chamber, is still relatively free to move within the chamber 60. As illustrated, the first and second outer surfaces 46 and 48 of the seal member 42 are respectively disposed in sealing engagement with correspondingly positioned inner surfaces of the chamber 60. Specifically, the first outer surface 46 of the seal member body 44 is disposed in movable, sealing engagement with the inner surface 70 of the closure or seal cap 64. Similarly, the second outer surface 48 of the seal member body 44 is disposed in movable sealing engagement with the inner surface 72 of the valve housing 67 or other structure creating a floor for the seal housing 60. Further, the seal member 42 and the chamber 60 are cooperatively dimensioned such that regardless of the position of the seal member 42 within the chamber 60, the height dimension of the seal member body 44 and/or its body wall 43 is sufficient to at least maintain a peripheral portion of the first and second outer surfaces 46 and 48 in sealing contact with the respective inner surfaces 70 and 72. In addition, the seal member 42 and the chamber 60 are cooperatively dimensioned such that the outer diameter of the seal member 42 relative to the inner diameter of the chamber 60 is such as to maintain the seal member 42 in generally surrounding relation relative at least to the inlet port 66, and also preferably to the outlet port 69 of the valve housing 67, and thereby, prevent gas from escaping out the inlet port 66 of closure or seal cap 64.

As clearly disclosed in FIGS. 4A and 5, however, the seal member 42 of the seal assembly 40 is unattached or unconnected to the seal housing 62, seal closure 64 or any other associated portion of the trocar housing 12. As such, the seal member 42 is freely movable, at least in a lateral or radial direction within the chamber 60, until such movement is limited by a contact between the outer cylindrical body wall 43 of the seal member 42 with the inner wall surface 63 or 68 of the chamber 60. In use, the seal member 42 can frequently be and will often be out of an axial alignment with a central longitudinal axis of the inlet port 66 and/or of the chamber 60, as schematically represented in FIG. 5 by phantom line 66′. This is true regardless of whether a medical instrument is being inserted into or has already been inserted into the seal assembly 40 and trocar assembly 10. This is also true when the instrument has been removed therefrom altogether as there is no biasing structure or other structure contemplated for causing the seal member 42 to be in or return to concentric alignment with the longitudinal axis 66′ and/or with the port 66. However, the amount of displacement of the seal member 42 out of axial alignment with the central longitudinal axis 66′ of the inlet port 66 is limited, as described above, by the cooperative dimensioning of the diameter of the outer body wall 43 of the seal member 42 relative to the inner diameter of the chamber 60, such that the seal member 42 is disposed in generally surrounding relation to the inlet port. For instance, the cooperative dimensioning of the seal member's outer diameter relative to the inner diameter of the chamber 60 should be capable of preventing the outer body wall 43 of the seal member 42 from moving enough within the chamber 60 so as to appear fully within the aperture defining port 66, which could interfere with the introduction of an instrument into port 66 and/or more likely into channel 50 of the seal member 42

This inventive feature of the seal assembly 40 offers several advantages. As one example, it more readily accommodates the frequent occurrence of a medical instrument being introduced into a trocar assembly 10 in an off-center or non-aligned manner relative to the central longitudinal axis of the trocar, or in this case to central longitudinal axis 66′ through the inlet port 66 of seal cap 64, as shown in FIG. 5. That is, it is well known in the medical field that the introduction of a medical instrument frequently occurs with the instrument being in an off-set, somewhat angularly oriented and/or non-aligned orientation relative to the central longitudinal axis of the trocar 10. With the present invention, the working distal tip of the medical instrument being introduced in a non-aligned manner will engage the seal member 42, and more particularly, the interior surface 45 thereof which defines the first open end 52 of the channel 50. As has been described, the flared configuration of interior surface 45 more readily accommodates the non-aligned introduction of a medical instrument. Also, however, the ability of the seal member 42 to freely move or “float” within the chamber 60 will facilitate the lateral displacement of the seal member 42 towards an inner side wall surface 63 of the chamber 60 in response to the instrument being introduced in a non-aligned manner. As a result, the seal member 42, and the channel 50 or aperture 58 within it in particular, is less likely to be damaged, whether punctured or otherwise, than are other seals of this type known in the art. As another example, the seal assembly 40 of the present invention also more readily maintains sealing engagement with the exterior surface of the medical instrument while it is being used during a surgery. That is, it is quite common for medical instruments, once passed through the trocar and into a patient's body cavity, to be pushed on and moved out of alignment with the longitudinal axis of the trocar, and this can often cause other sealing structures to form an oval or “egg shape.” The present invention, however, which allows the seal member 42 to move relatively freely within the chamber 60, accommodates this non-axial or out of alignment maneuvering of the instrument(s) during a surgery, and prevents or at least minimizes the escape of pressurized gas from the seal assembly 40. As set forth above, with the present invention, sealing engagement is still maintained even when the seal member 42 is laterally displaced, such that the outer body wall 43 or a portion thereof moves towards an inner side wall surface of the chamber 60 (such as at 63 or 68 in FIG. 4-A), typically until the shaft or rod of the medical instrument contacts the wall 65 defining the inlet port 66 in the seal cap 64. In addition, the cooperative dimensioning between the seal member 42 and the chamber 60 maintains sealing engagement, at least about the peripheral portions of the first and second outer surfaces 46 and 48, with the correspondingly disposed inner surfaces 70 and 72 of the closure or seal cap 64 and seal housing 62.

In order to facilitate the introduction of a medical instrument into the channel 50 and movement of the instrument within the assembly 40 with less friction, the seal member 42 is preferably structured to have lubricating characteristics, which should also facilitate the free “floating” travel of the seal member 42, at least in a lateral or radial direction, within the chamber 60. Such lubricating characteristics can be provided by coating the seal member 42, and particularly, the first and second outer surfaces 46 and 48 with a lubricant, such as with a coating of the polymer, parylene. Naturally, other lubricant coatings may be used and/or the elastic material of the body 44 can be made from a plastic or plastic-like material of a sufficiently low durometer to be slippery or to otherwise have inherent lubricating characteristics.

Referring now to FIG. 2, there is illustrated a more preferred embodiment of the seal member 42. This embodiment of the seal member 42 includes at least one sealing flange, but preferably, two sealing flanges, such as 76 and 78, as shown. The sealing flange or flanges 76 and 78 may be integrally formed with the seal member 42 continuously about the outer periphery of the respective, first and second outer surfaces 46 and 48. The sealing flange or flanges 76 and 78 preferably include a continuous or annular configuration which is/are further structured to extend laterally outward and beyond the respective outer surfaces 46 and 48. Each flange will also preferably have, for example, a small height dimension compared to the height dimension of the seal member 42, which in one embodiment may be as small as seven-thousandths (0.007), and further in the same embodiment, may angle upwardly at an angle of about ten degrees. The flange or flanges 76 and 78, and their orientation is believed to reliably maintain a movable sealing engagement of the seal member 42 with the respective inner surfaces 70 and 72 of the chamber 60, even when the transverse dimension of the seal member 42 does not precisely correspond to the transverse dimension of the chamber 60. By way of example only, in certain situations where the seal member 42 has at least a minimally less transverse dimension than that of the chamber 60 (e.g., the depth of the chamber 60), the respective sealing flanges 76 and 78, extending outwardly and beyond the corresponding outer surfaces 46 and 48, will maintain sealing engagement with the inner surfaces of the chamber 60, such as at 70 and 72, and although operating under a greater compression force should still move relatively smoothly and freely within the chamber 60. Therefore, regardless of the lateral displacement of the seal member 42 upon introduction of a medical instrument through the inlet port 66, a sealing engagement will be maintained and established at least about the periphery of the outer surfaces 46 and 48, due at least in part to the structure and disposition of the sealing flanges 76 and 78. Further, the sealing flanges 76 and 78 may have a greater elasticity than the majority of the seal member 42 due to their dimensions being small and/or thin. Of course, while the sealing flanges 76 and 78 may be attached or bonded onto the seal member 42, they are preferably integrally formed with and from the same elastomeric material as the seal member 42, including of the same durometer/hardness as well.

As set forth above, the seal member 42 of the seal assembly 40 is structured to accommodate sealing engagement with the exterior surface of a variety of medical instruments introduced through the channel 50, even when the diameter of such instruments vary, such as within the currently conventional range of about 3 mm to 15 mm or a smaller range thereof. As shown in FIGS. 3 and 5, the seal member 42 may include in one embodiment, but does not have to include, a web structure 56 in order to facilitate sealing engagement between the seal member 42 with the exterior surface of the smaller diameter instruments, such as in the range of 5 mm. The web structure 56 may be integrally formed with or applied to the seal member 42 on the interior of the channel 50 at approximately a mid portion thereof, and extends radially inward in surrounding relation to a centrally disposed aperture 58 extending through the web structure 56. Also, the web structure 56 may have an annular configuration which substantially surrounds the aperture 58. In order to adequately provide sealing engagement with the medical instruments of larger diametrical dimension, the transverse dimension of the channel 50 may in fact be made at least minimally larger than the 5 mm smaller diameter instruments. Accordingly, the provision of the web structure 56 should accommodate instruments having smaller diameters which may be equal to or less than the normal diameter of the channel 50. Therefore, when a smaller diameter instrument (in the range of 3 mm or 5 mm) is introduced through the channel 50, the exterior surface thereof will be sealing engaged, primarily by the annularly configured web structure 56, rather than a majority of the interior surface 45 of the remainder of the channel 50.

As noted previously herein, one feature of the present invention is the ability of the seal member 42 to freely move within the chamber 60 due to its not being connected or attached to any structure within the chamber 60, seal housing 62 or sealing closure 64. However, referring now to FIGS. 6 through 8, there is shown another possible embodiment for the present invention, which includes the provision of a positioning assembly, generally indicated as 80. The positioning assembly 80 comprises an elastic material skirt or like structure 82 having an enlarged or reinforced outer peripheral rim 84. The inner end of the skirt 82, as at 86, is integrally formed to the outer periphery of one of the first and second outer surfaces, such as at 46′. The skirt 82 is made from an elastic material and is of a relatively thin transverse dimension such that the elasticity or ability to stretch is greater than at least a majority of the body 44′. In its operative position, as shown in FIG. 6, the outer rim 84 is mounted or otherwise secured to the seal housing 62 and/or the under portion of the seal closure 64. As such, the disposition and structure of the positioning assembly 80 is such as to normally orient the seal member 42′ in a substantially aligned relation with the inlet port 66 of the seal closure 64. However, due to the elasticity of the surrounding skirt 82 of the positioning assembly 80, the seal member 44′ is allowed to freely move or “float” at least laterally within the chamber 60 such as when the interior surface of the body 44′ engages the distal end of the instrument being introduced through the inlet port 66. Therefore, it should be understood that the structural and operative features of the seal member 42′ render it substantially equivalent to the seal member 42 of the preferred embodiment(s) illustrated previously with respect to FIGS. 2 through 5.

With reference now to FIG. 9, the seal member 42′ is shown in another embodiment in a cross sectional view. In this embodiment, the seal member 42′ is formed to have at least two layers of materials, each with a different hardness or flexibility. For example, the main body 44′ of the seal member may be formed to be soft and flexible, such as in the range of zero (0) to five (5) or more, such as (10) durometers. In the illustrated embodiment, the interior surface 45′ of the seal member 42′ is formed to have a second layer or skin 47 having a harder, less flexible material, such as but not limited to, one in the range of fifty (50) to eighty (80) durometers. By way of example only, this skin 47 or layer may be more flexible, such as thirty (30) durometers, and may have a depth of about 0.010 or ten thousandths of an inch in depth. Ideally, this layer of harder skin 47 is disposed entirely or substantially completely about the interior surface 45′ of the seal member 42′ which defines the open end of the channel 50, and may only need to extend to or towards, if it extends at all, into the interior portions of the channel 50 towards an approximate mid-portion thereof. It is contemplated by the inventor hereof that this skin 47 with more firmness will resist damage, such as being punctured, etc., by a medical instrument upon its insertion in an off-center or non-aligned manner. The seal member of this embodiment may be formed in various ways, such as by a two-step silicone molding process using core pin and one or two molds, or by separately bonding or otherwise attaching the layers of different material hardness together.

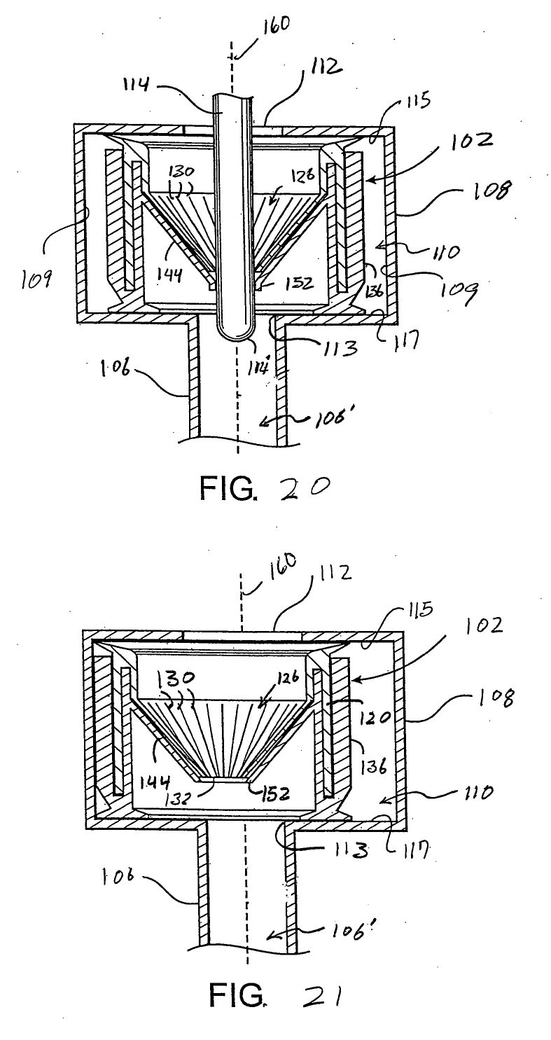

With reference now to FIGS. 11-22, there is illustrated another preferred embodiment of a seal assembly according to the present invention. The seal assembly, generally indicated as 100 in FIG. 11, is shown to include a seal member 102 structured to be used in combination with a trocar assembly, such as that shown at 104, schematically represented FIG. 10 or that shown at 10 in FIG. 1. Here again, the trocar assembly 104 is intended to be representative of a plurality of different trocar assemblies or like devices, with which the seal member 102 may be used and which are structured to facilitate the placement of medical instruments within the body cavity of a patient, such as during laprascopic surgery. While the trocar assembly 104 illustrated in FIG. 10 is absent certain structural and functional components frequently associated with conventional trocar assemblies, it does include an elongated cannula 106 through which the medical instrument passes as it enters a predetermined body cavity. As also schematically represented, the trocar assembly 104 includes a seal housing 108, more specifically disclosed in FIGS. 20 through 22, with the seal member 102 dimensioned and configured to be operatively disposed within an interior chamber 110 defined by the seal housing 108.

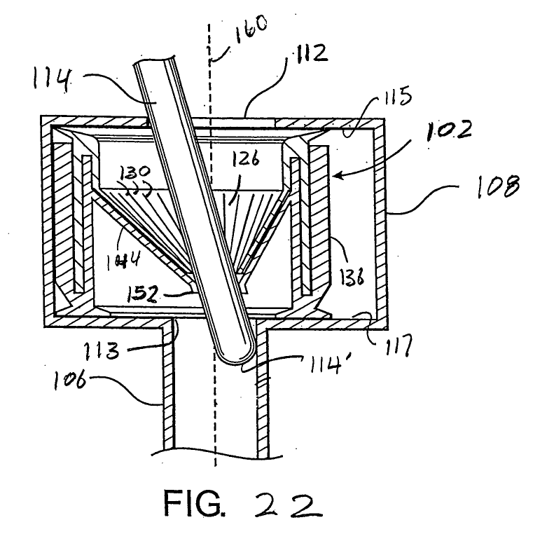

As with the other embodiments described herein with reference to FIGS. 1 through 9, the seal member 102 is also preferably unattached or not otherwise connected to the seal housing 108 nor to any other associated portion of the trocar assembly 104. As such, the seal member 102 is freely movable, at least in a lateral or radial direction, within the seal chamber 110 until such movement is limited by a contact between the outer cylindrical wall 136 of the seal member 102 and the inner wall surface 109 of the seal chamber 110, as best demonstrated in FIGS. 21 and 22, to be described in greater detail hereinafter. As also illustrated by FIGS. 20-22, the seal member 102 will often be disposed out of a coaxial alignment with a central longitudinal axis 160 of inlet port 112 and outlet port 113 and/or of the seal chamber 110. This offset, non-coaxial alignment may occur whether or not a medical instrument 114 is being inserted into the seal member 102 and/or the seal housing 108. However, the amount of displacement of the seal member 102 out of axial alignment with the central longitudinal axis 160 is limited, as described above, by the cooperative dimensioning of the outer diameter of the seal member 102, relative to the inner diameter of the seal chamber 110. Moreover, and as also demonstrated in the aforementioned FIGS. 20-22, opposite ends of the seal member 102 are always disposed in surrounding relation to each of the inlet and outlet ports 112 and 113 respectively, regardless of the positioning of the seal member 102 within the chamber 110. Accordingly, even when the seal member 102 is in the aforementioned offset orientation or alignment, it is always maintains a communicating relation with the inlet and outlet ports 112 and 113, respectively, as well as the interior of the cannula 106. As also set forth in detail herein, the frequent offset orientation of the seal member is at least partially due to the seal member 102 being dimensioned and structured for free lateral movement within the chamber 110. Moreover, and as with some of the additional preferred embodiments of the floating seal assembly of the present invention, a channel is formed within and along the interior of the seal member 102. As with the remainder of the seal member 102, the channel is disposable into and out of offset relation to the central longitudinal axis 160 of inlet and outlet ports 112 and 113 respectively, and the seal housing 108. The interior channel of the seal member 102 is dimensioned and configured to receive a medical instrument 114 there through as it passes through the trocar assembly 104.

Referring now to FIGS. 11-A and 18-19, the seal member 102 is seen to preferably comprise a multi-piece construction that is ideally defined by a first section 116 and a second section 118. Fabrication of the first and second sections 116 and 118 preferably occurs, but not necessarily have to occur, independently of one another, and as such the first and second section 116 and 118 are snugly or matingly assembled prior to being disposed in an operative position, shown in FIG. 19, and within the seal chamber 110, as represented in FIGS. 20 through 22. As shown in FIG. 13, the first section 116 includes an outer cylindrical wall 120 surrounding the interior thereof and two oppositely-disposed, open ends, as at 122 and 124. The first section 116 also ideally includes an inner sleeve generally indicated as 126. The inner sleeve 126 is disposed on the interior of the first section 116 and preferably includes a substantially convergent configuration, which may be more specifically defined by a substantially inverted, conical configuration. As shown in FIG. 13, the convergent configuration extends along a substantial portion of the inner sleeve 126, and wherein the upper peripheral boundary thereof may be defined by a skirt 128 having a more cylindrical configuration somewhat similar to but inwardly of the outer cylindrical wall 120.

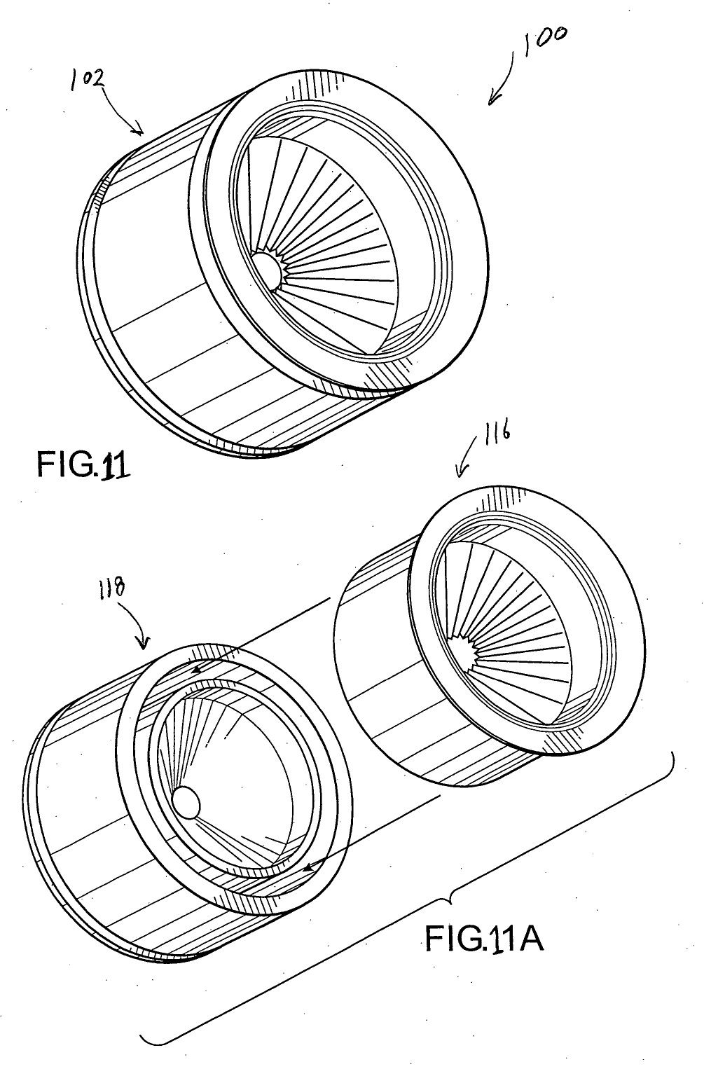

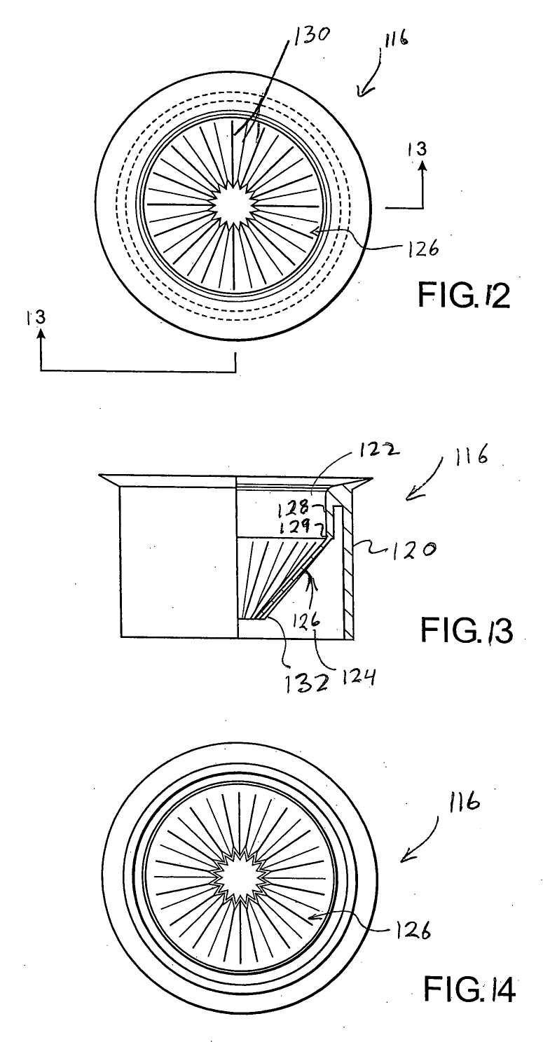

Referring now to FIG. 12, the inner sleeve 126 ideally includes an irregular surface configuration on an outer or exposed face or surface 130, which also extends along a substantial portion or at least a majority of a length of the convergently configured portion, as is perhaps best shown in FIG. 13. In a most preferred embodiment, the irregular surface configuration of the outer face 130 comprises a “pleated” construction. This pleated construction includes a plurality of elongated pleat-like protrusions extending at least minimally outward from the exposed face 130 and converging substantially along at least the majority of the length of the exposed face 130 of the inner sleeve 126, as shown in FIGS. 12-14. This pleated construction 130 may also be defined by a plurality of elongated grooves or recesses generally converging from upper periphery 129 of the sleeve 126 to an exit end or extremity of the sleeve 126, as at 132, shown in FIG. 13. While the irregular surface configuration of the outer face 130 is preferably defined by the aforementioned pleated construction, it should be noted that other irregular surface configurations may be utilized or applied so as to exhibit preferred performance characteristics. Such performance characteristics include, but are not necessarily limited to, the interruptive engagement of the inner sleeve 126 with an instrument 114 passing into and through the seal housing 108 and the at least partial guidance of the instrument to and through seal structure 144, as will be described in greater detail hereinafter.

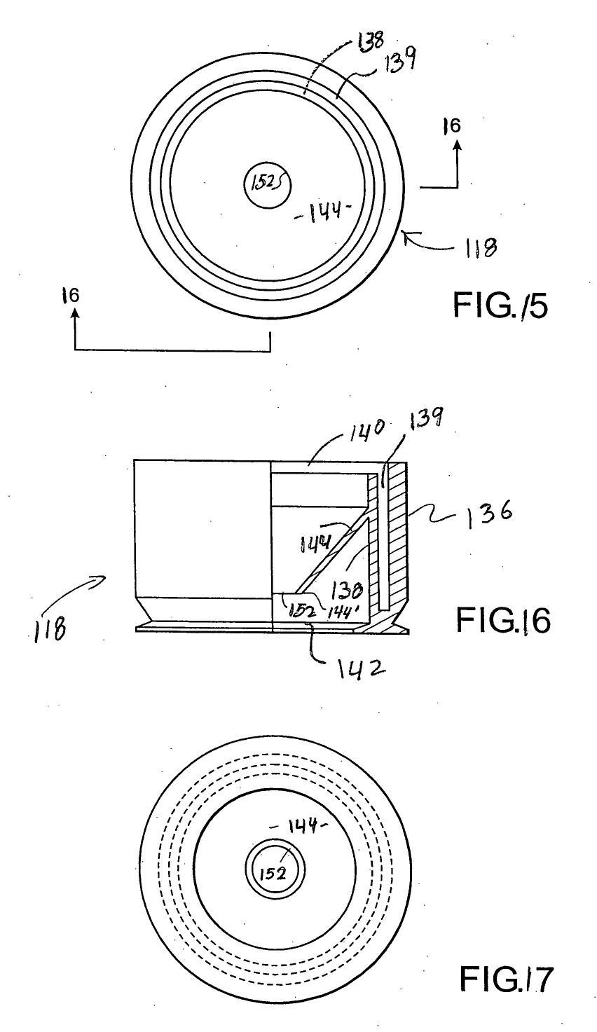

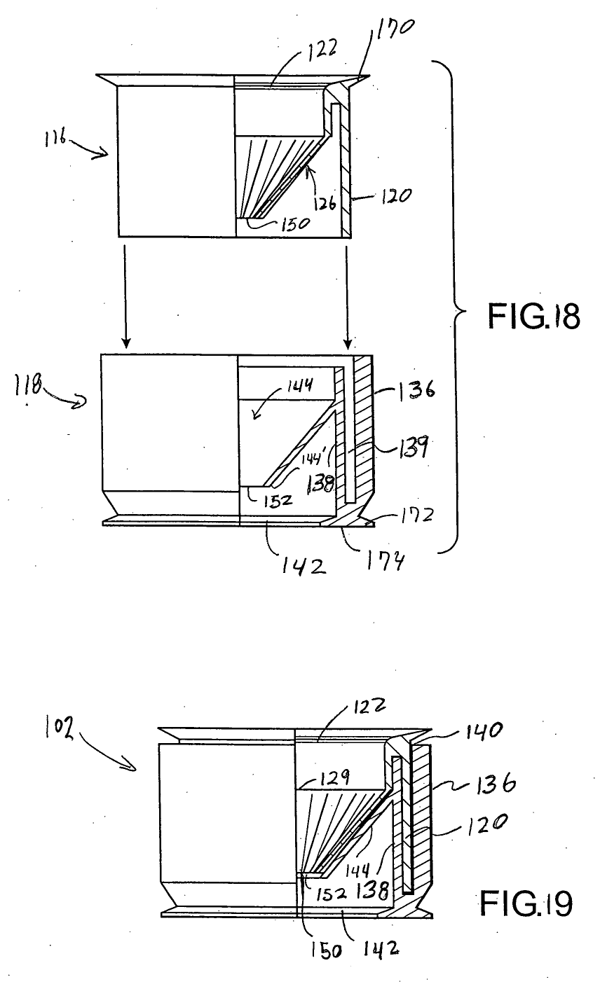

With reference now to FIGS. 15 through 19, the second section 118 of the seal member 102 is illustrated as being cooperatively structured with the first section 116. Although the first and second sections 116 and 118 are structured and disposed to be matingly and snugly joined together, once assembled into an operative position shown in FIG. 19, these sections do not have to be and preferably are not bonded or otherwise adhered together. In other words, first and second sections 116 and 118 may be removably but yet stably connected when the seal member 102 is in its preferred, operative position as represented in FIGS. 18 through 22. Accordingly, and as is perhaps best illustrated in FIG. 16, the second section 118 preferably includes an outer cylindrical wall 136 and an inner cylindrical wall 138. An annular recess 140 is ideally formed between the inner and outer cylindrical walls 136 and 138 and is disposed, dimensioned and configured for receipt and engagement with the outer cylindrical wall 120 of the first section 116, as clearly demonstrated in FIG. 19. As with the first section 116, the second section 118 also includes oppositely disposed open ends 140 and 142 which facilitate the passage of an instrument 114 through the channel formed within and passing through the interior of the seal member 102, as demonstrated in FIGS. 20 and 21.

As is also shown in FIGS. 15-17, the second section 118 of the seal member 102 additionally comprises a seal structure 144, which preferably includes a substantially corresponding configuration as that of the inner sleeve 126 of the first section 116. More specifically, the seal structure 144 includes a convergently configured portion that preferably has, but does not have to have, an inverted, conical configuration. Moreover, the cooperative structuring, dimensioning and positioning of the inner sleeve 126 and seal structure 144 facilitates their relative dispositions, as represented in FIGS. 19 through 21, when the seal member 102 is in the preferred, operative position on the interior of chamber 110 of seal housing 108. Accordingly, once operatively disposed, the inner sleeve 126 is disposed in interruptive relation to the instrument 114 as it passes into the chamber 110 of the seal housing 108 and into and through the interior channel of the seal structure 102.

In order to further facilitate the passage of the instrument 114 through the seal member 102, concurrently to establishing a sealing engagement between the seal structure 144 and the exterior surface of the instrument 114, both the inner sleeve 126 and the seal structure 144 comprise an “apertured construction”. As shown in FIGS. 18 and 19, the apertured construction is more specifically defined by an opening 150 formed in the exit end or downstream end 132 of the inner sleeve 126 and a sealing aperture 152 formed in the exit end or downstream end 144′ of the seal structure 144. As should be clear from these drawings, the opening 150 and the sealing aperture 152 at least partially define the aforementioned interior channel extending through the seal member 102 and along which the instrument 114 passes as it travels through the seal member 102. Accordingly, the elasticity of the material from which the seal structure 144 is formed, as well as the dimensioning of the sealing aperture 152, will facilitate the formation of a sealing engagement between the periphery of the sealing aperture 152 and the exterior surface of the instrument 114, as demonstrated in FIGS. 20 and 21. Escape of insufflation gas from the body cavity of the patient, through the lumen 106′ of the cannula 106 is thereby eliminated or significantly reduced.

As also clearly represented in FIGS. 19 through 22, cooperative structuring of the inner sleeve 126 and the seal structure 144 facilitates a substantially continuous positioning of the inner sleeve 126 in interruptive relation to the distal end or extremity 114′ of an instrument 114 passing into the interior of seal member 102. The interruptive disposition of the sleeve 126 reduces the possibility of damage being done to the seal structure 144 such as by being penetrated or torn by the sometimes pointed extremity 114′ of the instrument 114. As represented, the interruptive engagement of the instrument with the inner sleeve 126 is substantially assured by the sleeve 126 being disposed between the seal structure 144 and the open end 122 disposed contiguous to the entrance and/or upstream end of the seal member 102. For purposes of clarity, it is emphasized that the terms “entrance end”, “exit end” “upstream end” and/or “downstream end” are used herein with reference to the direction of travel of the instrument 114 along the channel formed within the seal member 102 and as the instrument 114 passes into the inlet port 112 and through and outwardly from the outlet port 113.

Still referring to FIGS. 19 through 22, it can be observed that the cooperative dimensioning, configuring and structuring of the inner sleeve 126 and the seal structure 144 serve to substantially align the opening 150 and the sealing aperture 152 in coaxial relation with one another. Such coaxial alignment normally, but not exclusively, occurs absent the presence of an instrument 114 passing through the seal member 102. As also set for the above, the free lateral or floating movement of the seal member 102 within the chamber 110 frequently results in the central longitudinal axis of the seal member 102 being offset or out of alignment with the central longitudinal axis 160 of the seal housing 108 and seal chamber 110, as demonstrated in FIG. 21. In such situations, the opening 150 and the sealing aperture 152 may be normally aligned in coaxial orientation with one another, absent the presence of an instrument 114 in the seal member 102. However, in use passage of an instrument 114 through the seal member 102 typically occurs with the instrument 114 disposed at any of a plurality of skewed angular orientations as represented in FIG. 22, rather than in a coaxial relation to the central longitudinal axis 160 as demonstrated in FIG. 20.

Accordingly, due to the formation of the inner sleeve 126 and the seal structure 144 from an elastic, flexible material, such as an appropriate elastomeric material, the instrument 114 and in particular the extremity 114′ will be guided by the inner sleeve 126 into and through the sealing aperture 152 in a manner which lessens the possibility of damage being done to the seal structure 144. As such, sealing engagement of the periphery of the sealing aperture 152 with the outer surface of the instrument 114 is effectively accomplished. Further, the pleated construction or other irregular surface configuration of the outer face 130 of the inner sleeve 126 will further facilitate the guidance of the instrument 114, and in particular the extremity 114′, into and through the sealing aperture 152. Also, depending on the specific structural features of the irregular surface configuration utilized, the outer face 130 may also serve to reduce frictional engagement with and resistance to passage of an instrument 114 through the seal member.

Preferably, the elastomeric material from which the inner sleeve 126 and the seal structure 144 are formed may be the same or substantially equivalent, at least in terms of demonstrating sufficient flexibility, elasticity, etc. However, the material from which the inner sleeve 126 is formed may be structured to demonstrate a more significant resistance to being punctured, torn or otherwise damaged by the entering extremity 114′ of the instrument 114. Therefore, one preferred embodiment of the seal member 102 may include inner sleeve 126 being formed of a material having a durometer reading, such as generally about in the range of 80 durometers. In such situations, the material of the seal structure 144 may or may not have a lower durometer reading so as to demonstrate sufficient elasticity to effectively establish sealing engagement between the periphery of the sealing aperture 152 and the outer surface of the instrument is better facilitated. However, at least one preferred embodiment may comprise the durometer readings of the inner sleeve 126 and the seal structure 144 being substantially the same. Accordingly, in order to provide sufficient resistance to being damaged by the entering instrument 114, the inner sleeve may have an increased thickness.

The alternative preferred embodiment of the seal member 102 shown in FIGS. 11-22 can additionally include one or more other features similar to other preferred embodiments described previously herein. For example, and as shown in FIG. 18, the first section 116 of the seal member 102 may additionally comprise a sealing flange 170 which may be integrally formed thereon. As represented, the sealing flange 170 will preferably extend, but does not have to extend, continuously about the outer periphery and in surrounding relation to the open end 122. Ideally, the sealing flange 170 ideally includes a continuous, annular configuration structured to extend laterally and angularly outward beyond the respective open end 122 and into sealing engagement with the interior surface 115, as represented in FIGS. 20-22. As such, the sealing flange 170 will always surround the inlet port 112 regardless of the position or operative orientation of the seal member 102 within the seal chamber 110.

As also shown in FIG. 18, the second section 118 of the seal member 102 will also ideally include a sealing flange 172 extending about the periphery of the open end 142 and also includes a continuous, annular configuration. However, the sealing flange 172 extends laterally outward resulting in a substantially flat sealing surface 174 disposed in movable but sealing engagement with the interior floor surface 117 of the seal chamber 110. A structural modification of the second section 118 is represented in FIG. 16A, wherein a sealing flange 172′ extends laterally and substantially angularly outward from the open end 142 and is therefore similarly structured and configured to the sealing flange 170 associated with the first section 116, as described in detail above. In either embodiment, the sealing flange 172 and 172′ establishes a movable, but sealing engagement with the floor or inner surface 117 regardless of the position or orientation of the seal member 102 and operatively disposed within the interior of seal chamber 110.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A seal assembly for use with a trocar or like device, said seal assembly comprising:
a seal member including a first section and a second section cooperatively structured to define a channel extending through said first and second sections,
a seal structure connected to said second section and disposed and structured to sealingly engage an instrument passing into and through said channel,
a sleeve connected to said first section and disposed within said seal member up stream of said seal structure along said channel and in interruptive relation to the instrument passing into and through said channel, and
both said first and second sections comprising an apertured construction which at least partially defines said channel.

2. A seal assembly as recited in claim 1 wherein said sleeve is formed from a material having a higher durometer reading than a material from which said seal structure is formed.

3. A seal assembly is recited in claim 1 wherein said sleeve comprises and an irregular surface configuration extending over at least a portion of an outer face thereof.

4. A seal assembly as recited in claim 3 wherein said irregular surface configuration comprises a substantially pleated construction.

5. A seal assembly as recited in claim 4 wherein said pleated construction extends along at least a majority of said outer face longitudinally between an outer end and an inner end of said sleeve.

6. A seal assembly as recited in claim 5 wherein said pleated instruction is disposed and dimensioned to facilitate guidance of the instrument along said channel and into sealing engagement with said seal structure.

7. A seal assembly as recited in claim 3 wherein said irregular surface configuration is disposed and structured to at least partially reduce frictional engagement between said outer face and instrument passing into and along said channel.

8. A seal assembly as recited in claim 3 wherein said irregular surface configuration is disposed and structured to facilitate guidance of the instrument along said channel and into sealing engagement with said seal structure.

9. A seal assembly as recited in claim 1 wherein said sleeve and said seal structure are not directly connected to one another.

10. A seal assembly as recited in claim 1 wherein said apertured construction comprises a sealing aperture formed in said seal structure, said sealing aperture disposed and dimensioned to establish sealing engagement between said seal structure and an instrument disposed within said channel.

11. A seal assembly as recited in claim 10 wherein said apertured construction further comprises an opening formed in said sleeve and dimensioned to receive the instrument there through, said opening disposed along said channel in at least partially aligned relation with said sealing aperture.

12. A seal assembly as recited in claim 11 wherein said sleeve and said seal structure each comprise a convergently configured portion extending along said channel at least partially between respective entrance and exit portions of each of said sleeve and seal structure.

13. A seal assembly as recited in claim 12 wherein each of said convergently configured portions substantially terminate at a downstream extremity of a corresponding one of said sleeve and said seal structure.

14. A seal assembly as recited in claim 13 wherein each of said downstream extremities are further defined by corresponding ones of said opening and said sealing aperture.

15. A seal assembly as recited in claim 12 wherein said convergently configured portions are disposed in aligned disconnected relation to one another along at least a majority of their corresponding lengths.

16. A seal assembly as recited in claim 15 wherein said aligned relation is at least partially defined by said sleeve disposed in an interruptive relation to an instrument passing into and along said channel and between the instrument and said seal structure

17. A seal assembly as recited in claim 1 wherein said first and second sections are removeably connected to one another to define an operative orientation of said seal member.

18. A seal assembly as recited in claim 1 wherein each of said first and second sections comprises a cylindrical outer wall having oppositely disposed open ends, correspondingly disposed ones of said open ends defining an entrance and an exit end of said seal structure when said seal member is and said operative orientation.

19. A seal assembly as recited in claim 18 wherein said operative orientation is further defined by said cylindrical outer walls disposed in removable telescoping engagement with one another.

20. A seal assembly as recited in claim 19 wherein said telescoping engagement comprises said cylindrical outer wall of said first section disposed in an interiorly concentric relation to said cylindrical outer wall of said second section.

21. A seal assembly as recited in claim 20 wherein said second section comprises a recessed groove disposed and dimensioned to receive said cylindrical outer wall as said first section their in.

22. A seal assembly for use with a trocar or like device structured to introduce a medical instrument into a body cavity, said seal assembly comprising:
a seal housing including an interior chamber having an inlet port and an outlet port,
said chamber comprising oppositely positioned inner surfaces each disposed contiguous to a different one of said inlet port and said outlet port and extending radially outward there from,
a seal member comprising first and second sections and a channel extending there through, said seal member unconnected to said housing and dimensioned and structured for free lateral movement within said chamber and disposable into and out of substantially coaxial alignment between said channel and said inlet and outlet ports,
a seal structure connected to said second section and disposed and structured to sealingly engage an instrument passing into and through said channel,
a sleeve moveably connected to said first section and disposed within said seal member upstream of said seal structure along said channel and in an interruptive relation to the instrument passing into and through said channel, and
both said first and second sections comprising an apertured construction which at least partially define said channel.

23. A seal assembly as recited in claim 22 wherein said apertured construction at least partially comprises a sealing aperture formed in said seal structure at an exit extremity thereof, said sealing aperture disposed and dimensioned to establish sealing engagement between said seal structure and an instrument disposed within said channel.

24. A seal assembly as recited in claim 23 wherein said apertured construction further comprises an opening formed in said sleeve at an exit extremity thereof and dimensioned to receive the instrument there through, said opening disposed along said channel in at least partially aligned relation with said sealing aperture.

25. A sealing assembly as recited in claim 24 wherein said sleeve and said seal structure each comprise convergently configured portions disconnected from one another and extending long said channel at least partially between respective entrance portions of said sleeve and said seal structure and said opening and said sealing aperture.

26. A seal assembly as recited in claim 25 wherein said convergently configured portions are disposable in aligned relation with one another along at least a majority of corresponding lengths of said sleeve and said seal structure.

27. A seal assembly as recited in claims 26 relation is at least partially defined by said sleeve disposed between said seal assembly and an instrument passing into and along said channel and said sleeve disposed in interruptive relation to the instrument.

28. A seal assembly as recited in claim 22 wherein said sleeve comprises an irregular surface configuration extending over at least a portion of an outer face thereof.

29. A seal assembly as recited in claim 28 wherein said irregular surface configuration is disposed and structured to at least partially reduce frictional engagement between said outer face and an instrument passing into and along said channel.

30. A seal assembly as recited in claim 28 wherein said irregular surface configuration is disposed and structured to facilitate guidance of the instrumental along said channel and into sealing engagement with the seal structure.

31. A seal assembly as recited in claim 28 wherein said irregular surface configuration comprises a substantially pleated construction extending along at least the majority of said outer face longitudinally between an entrance end and an exit end of said sleeve.

32. A seal assembly as recited in claim 22 wherein said sleeve is formed from a material having a higher durometer reading than a material from which said seal structure is formed.

33. A seal assembly as recited in claim 22 when said seal member comprises a multi-piece construction at least partially defined by said first and second sections being detachably connected to one another.

34. A seal assembly as recited in claim 33 wherein said sleeve is integrally connected to said first section and said seal assembly integrally connected to said second section; said sleeve and said seal structure removable from one another upon detachment of said first and second sections.
